(19) United States
(12) Patent Application Publication
(10) Pub. No.: US 2008/0197526 A1
(43) Pub. Date: Aug. 21, 2008

(54) Process for Preparing Composites Using Epoxy Resin Formulations

(76) Inventors: Asjad Shafi, Lake Jackson, TX (US); Nikhil E. Verghese, Lake Orion, MI (US); Allan James, Oxford, MI (US); John J. Penkala, Bay City, MI (US)

Correspondence Address: The Dow Chemical Company;Gary C. Cohn, P. O. Box 313, Huntingdon Valley, PA, 19006, US

(21) Appl. No.: 12/025,835

(22) Filed: Feb. 5, 2008

Related U.S. Application Data
(60) Provisional application No. 60/902,035, filed on Feb. 16, 2007.

(51) Int. Cl. B29C 67/24; C08G 65/04

(52) U.S. Cl. 264/137; 528/425

(57) ABSTRACT

Epoxy composites are prepared by separately preheating an epoxy resin and a hardener; mixing the preheated epoxy resin and preheated hardener to form a hot reaction mixture and curing the hot reaction mixture in the presence of a reinforcement until the mixture cures to form a composite having a polymer phase with a glass transition temperature of at least 150° C.

### CROSS-REFERENCE TO RELATED APPLICATION

This application claims benefit of U.S. Provisional Patent Application No. 60/902,035, filed 16 Feb. 2007.

### BACKGROUND OF THE INVENTION

This invention relates to a process for preparing composites using epoxy resins formulations.

Epoxy resin formulations are used in a number of processes to form reinforced composites. These processes include, for example, molding processes such as those known as resin transfer molding (RTM), vacuum-assisted resin transfer molding (VARTM), Resin Film Infusion (RFI) and Seeman Composites Resin Infusion Molding Process (SCRIMP), as well as pultrusion and other processes. What these processes have in common is that an epoxy resin formulation is applied to a reinforcing agent and cured in the presence of the reinforcing agent. A composite is formed that has a continuous polymer phase (formed from the cured epoxy resin) in which the reinforcing agent is dispersed.

The various processes can be used to produce a wide range of products. The molding processes (such as RTM, VARTM, RFI and SCRIMP) are used to produce high strength parts which are used, for example, in seating, automobile body panels and aircraft components. In these process, a woven or matted fiber perform is inserted into a mold cavity. The mold is closed, and the resin is injected into the mold. The resin hardens in the mold to form a composite, and is then demolded.

Pultrusion processes are used to form composite articles which have a uniform cross-section. These include reinforcing rods, beams, “C” sections, “I” sections, tubes and other longitudinally hollow articles, tapes, and other shapes. Pultrusion processes differ from the molding processes described above because no mold is used. Instead, continuous reinforcing fibers are pulled through a resin bath where they become coated with resin, and then are passed through one or more dies where the resin/fiber mixture is continuously formed into an elongated article having a constant cross-section.

As is the case with many other manufacturing processes, the economics of these composite manufacturing processes is heavily dependent on operating rates. For molding processes, operating rates are often expressed in terms of “cycle time”. “Cycle time” represents the time required to produce a part on the mold and prepare the mold to make the next part. Cycle time directly affects the number of parts that can be made on a mold per unit time. Longer cycle times increase manufacturing costs because overhead costs (facilities and labor, among others) are greater per part produced. If greater production capacity is needed, capital costs are also increased, due to the need for more molds and other processing equipment. For these reasons, there quite often is a desire to shorten cycle times when possible.

When an epoxy resin is used in the molding processes described above, the predominant component of cycle time is the amount of time required for the resin to cure. Cure times of 15 minutes or more are often required, especially if the part is large or complex. Therefore, cycle times and production costs can be reduced if the time required for the resin to cure can be shortened. In pultrusion processes, a faster cure relates to higher operating rates.

Cure times are in many cases dictated by the amount of time that is required for the resin to develop a high glass transition temperature (T_{g}). For many applications, a T_{g} of 150° C. or more is needed. The T_{g} of an epoxy resin depends on several factors, including the particular epoxy resin and hardeners that are used, but the main determinant of T_{g} is the crosslink density of the polymer. More highly crosslinked resins tend to have higher glass transition temperatures. Crosslink density depends on the starting materials, and the extent to which those starting materials can react to develop a high molecular weight, highly crosslinked polymer. In epoxy resins, polymer T_{g} increases through the curing process, as the polymer molecular weight and crosslink density increase.

The extent to which T_{g} can develop is often limited by an event known as “vitrification”. Vitrification refers to the formation of a hard, glassy polymer mass before curing is completed. Once a hard polymer mass is formed, it is difficult for free epoxide groups and reactive sites on hardener molecules to “find” each other and react to complete the cure. As a result, polymer T_{g} sometimes does not develop as much as expected when epoxy resins are used.

Faster curing can be promoted through the use of catalysts and, in some cases, highly reactive hardeners. There are other problems associated with faster curing systems such as these. One problem is simply cost, as catalysts and special hardeners tend to be expensive relative to the remainder of the raw materials. In addition, systems which cure more rapidly tend to have short “open times”. “Open time” refers roughly to the time after the components are mixed that it takes for the polymer system to build enough molecular weight and crosslink density that it can no longer flow easily as a liquid, at which time it can no longer be processed using reasonable conditions. Open times are important in composite-manufacturing processes for two main reasons. First, the mixed components must be transferred into the mold or die. This becomes difficult or impossible as viscosity increases with growing polymer molecular weight and crosslink density. Second, the mixed components must be low enough in viscosity that they can flow easily around and between the reinforcing fibers. If the viscosity of the polymer system is too high, it cannot flow easily around the fibers, and the resulting composite will have voids or other defects.

As a result of these problems, there is a need to develop a method for producing composites using an epoxy resin, in which cure time is reduced, good quality composites are formed and the polymer phase of the composite develops a high T_{g}.

### SUMMARY OF THE INVENTION

This invention is a process for forming a composite, comprising

a) pre-heating an epoxy resin and a hardener while keeping them separated;
b) mixing the pre-heated epoxy resin and pre-heated hardener to form a hot reaction mixture;
c) curing the hot reaction mixture in the presence of at least one reinforcement to form a composite having a polymer phase, until the polymer phase attains a glass transition temperature of at least 150° C.,
wherein steps b) and c) are conducted such that the hot reaction mixture is maintained at all times above the instantaneous T_{g} of the polymer phase.

The process of the invention is useful to form various types of composite products. The reinforcement can take any of several forms, depending on the particular process and product. Continuous, parallel fibers, woven or matted fiber performs, short fibers and even low aspect ratio reinforcing agents can be used in various embodiments of the invention.

In certain preferred embodiments, the invention is a process for forming a composite, which comprises

a) pre-heating an epoxy resin and a hardener while keeping them separate;
b) mixing the pre-heated epoxy resin and pre-heated hardener to form a hot reaction mixture;
c) introducing the hot reaction mixture into a closed mold containing at least one fiber preform, and
d) curing the hot reaction mixture in the mold in the presence of at least one reinforcement to form a composite having a polymer phase, until the polymer phase attains a glass transition temperature of at least 150° C.,
wherein steps b), c and d) are conducted such that the hot reaction mixture is maintained at all times above the instantaneous T_{g} of the polymer phase.

The processes of the invention provide several advantages. Cure times tend to be very short. Cure times are commonly less than 10 minutes and are often 5 minutes or less, with development of the polymer phase T_{g} to 150° C. or greater. During the first stages of cure, the reaction mixture tends to be low enough in viscosity that it can be transferred easily into the mold or resin bath, where it readily flows around the reinforcing particles or fibers to produce a product having few voids. Because of these advantages, the process of the invention is useful for producing a wide variety of composite products, of which automotive and aerospace components are notable examples.

### DETAILED DESCRIPTION OF THE INVENTION

In the process of the invention, an epoxy resin and hardener are pre-heated and mixed to form a hot reaction mixture. The hot reaction mixture reacts in the presence of a reinforcing agent to form a composite. The composite has a polymer phase which has a glass transition temperature of 150° C. or greater, as measured by the dynamic thermal mechanical analysis (DTMA) method described below. The reaction may be performed in a mold, or in the case of a pultrusion or similar process, in a resin bath and/or one or more dies that impart a specific cross-sectional shape to the composite. The process will first be described with regard to molding processes.

The temperature of the reaction mixture during the mixing step, the step of introducing it into the mold, and during the curing process is significant. When the preheated epoxy resin and preheated hardener are mixed together, they will start to react together to form a high molecular weight, crosslinked polymer. As the molecular weight grows, and the polymer becomes more crosslinked, the T_{g} of the polymer will increase. The T_{g} of the polymer at any point in time during the mixing, mold-filling and curing process is referred to herein as the “instantaneous” T_{g}. During early stages of the polymerization, the T_{g} tends to be low, but increases as the crosslinking reaction proceeds.

In this invention, the temperature of the reaction mixture during the mixing, mold-filling and curing steps is maintained above the instantaneous T_{g} until at least such time as the T_{g} of the polymer reaches 150° C.

The temperature of the reaction mixture when it is first formed by mixing the epoxy resin and hardener is preferably at least 80° C. A temperature of 80° C. or more provides the advantages of reducing the viscosity of the mixture and of providing for a fast initial reaction. During this early part of the process, the reduction in viscosity due to the elevated temperature tends to offset any increase in viscosity which may occur due to the polymerization of the raw materials. The temperature may be any higher temperature up to that at which the epoxy resin or hardener (or other, optional components, if any) degrade significantly or volatilize, provided that the reaction mixture can be introduced into the mold before it becomes highly viscous or gels. There is generally little advantage in using a temperature of greater that 160° C. at this point. A temperature from 80 to 130° C. when the reaction mixture is formed is preferred.

The epoxy resin and hardener are separately heated to above room temperature (˜25° C.) prior to mixing them together, so that a hot reaction mixture is formed immediately upon mixing them. The epoxy resin and hardener may each be heated to a temperature of 50° C., preferably 80° C., or higher prior to mixing. As before, the maximum temperature may be any temperature at which the particular component does not degrade significantly or volatilize. Also as before, there is little advantage in heating the components to a temperature of greater than 160° C. before mixing, and a preferred preheating temperature is from 80 to 130° C. In a preferred embodiment, one component or the other may be heated to a somewhat lower temperature than mentioned, if the other is heated to a temperature somewhat higher than 80° C., so the temperature of the mixture when it forms is 80° C. or higher.

As will be discussed in more detail below, the hot reaction mixture may contain optional components, in addition to the epoxy resin and the hardener. It is often convenient to blend these with either the epoxy resin or the hardener, and preheat them together with the epoxy resin or hardener, as the case may be, before mixing the epoxy resin and hardener together. It is also possible to mix in one or more of such optional components separately, either at the same time the epoxy resin and hardener are mixed, or afterward. If mixed in afterward, they are preferably mixed in immediately after the epoxy resin and hardener are mixed, prior to introducing the reaction mixture into the mold. If any optional component is mixed into the reaction mixture after the epoxy resin and hardener are mixed, the addition of the optional component(s) should not cool the reaction mixture below the temperatures described before. Any optional component mixed in separately from the epoxy resin and hardener is preferably preheated. Preheating temperatures for optional components are as stated before, preferably at least 80° C., up to 160° C. and more preferably from 80 to 130° C.

The hot reaction mixture is introduced into the mold, rapidly enough that the reaction mixture does not become highly viscous or form significant gels before the mold is filled. It is generally preferred to transfer the reaction mixture to the mold within one minute of the time the epoxy resin and hardener are first contacted. Generally, shorter transfer times are better, and the reaction mixture is preferably transferred into the mold within 1 minute, more preferably within 30 seconds and even more preferably within 10 seconds of the time the epoxy resin and hardener are first contacted.

During the time from when the epoxy resin and the hardener are first mixed until the time the reaction mixture is introduced into the mold, the temperature of the reaction mixture is maintained above the instantaneous T_{g} of the polymer that is beginning to form in the reaction mixture. The reaction mixture is preferably maintained at a temperature of at least 80° C. during this time, preferably from 80 to 160° C. Heat may be applied to the reaction mixture (typically via the handling equipment) if needed, or if it is desired to increase the reaction mixture temperature during this period.

The reaction mixture is cured in the mold, again at a temperature above the instantaneous T_{g} of the polymer. Because the mold (and the reinforcement material, if contained within the mold prior to introducing the reaction mixture) can act as a heat sink and cool the reaction mixture, it is preferred to preheat the mold (and its contents, if any), to at least the temperature of the incoming reaction mixture, preferably to at least 130° C. and more preferably to at least 150° C., prior to introducing the reaction mixture. It is within the scope of the invention to gradually heat the mold (and its contents) as the reaction mixture cures and the T_{g} of the polymer increases, at all times maintaining the temperature of the reaction mixture above the instantaneous T_{g}. However, it is preferred to simply heat the mold (and its contents) to some temperature above 150° C. and maintain them (and the reaction mixture) at that temperature during the curing process. The mold and its contents are preferably preheated to a temperature of from 160 to 230° C. and maintained within those temperature ranges until the composite is ready to be demolded.

If the temperature of the reaction mixture is less than 150° C. at the time it is introduced into the mold, it is preferred to use conditions of heating such that the reaction mixture is heated rapidly to above 150° C. It is especially preferred to heat the reaction mixture at a rate of at least 50° C./minute under such cases, until a temperature of at least 150° C. is obtained.

Demolding is performed after the polymer phase of the composite has cured sufficiently to attain a T_{g} of at least 150° C. The cured polymer is preferably cooled below its glass transition temperature, particularly to at least 25° C. below the glass transition temperature, prior to demolding the composite. In most cases, the reaction mixture cures rapidly enough, under conditions in accordance with the invention, that the polymer phase develops a T_{g} of 150° C. or more within 10 minutes, preferably within 5 minutes and more preferably within 3 minutes, after the epoxy resin and hardener are mixed. Consequently, in-mold residence times are typically no greater than 10 minutes and more preferably no more than 5 minutes and even more preferably no more than 3 minutes. In-mold residence times can be as little as 1 minute or even 45 seconds.

As it is difficult to measure T_{g} directly within the mold, in most cases the necessary in-mold residence times will be established empirically with respect to a particular reactive system, equipment and curing conditions.

It is believed (although the invention is not limited to any theory) that the rapid curing is promoted in part by the formation of a hot reaction mixture. Because the epoxy resin and hardener are heated when they are mixed, and then kept hot, they tend to react and build molecular weight quickly after they are mixed. The development of the polymer network increases viscosity, but the viscosity increase contributed by the polymerization is at least partially offset, during early stages of the reaction, by the elevated temperature of the mixture. As a result, the reaction mixture is believed to remain fluid enough to be processed easily, and in particular to retain the ability to flow around and between the filaments of a preform or other fibrous reinforcement. Typical open times are from 15 seconds to 3 minutes, especially from 30 seconds to 2 minutes. After the mold is filled, the temperatures employed are believed to prevent or at least delay vitrification. As a result of the high temperatures and the lack of vitrification, the polymer tends to develop a high T_{g} quickly, and as a result, short demold times can be achieved.

The particular equipment that is used to preheat the components, mix them, and transfer the mixture to the mold is not considered to be critical to the invention, provided that temperature control can be provided as described before, and the reaction mixture can be transferred to the mold before it attains a high viscosity or develops significant amounts of gels. The process of the invention is amenable to RTM, VARTM, RFI and SCRIMP processing methods and equipment (in some cases with equipment modification to provide the requisite heating at the various stages of the process), as well as to other methods.

The epoxy resin and hardener are preferably stored in heated tanks. It is also possible to transfer the epoxy resin and/or hardener to a mixing apparatus via heated lines, and in that manner heat the resin and/or hardener as they are transferred to the mixing apparatus.

The mixing apparatus can be of any type that can produce a highly homogeneous mixture of the epoxy resin and hardener (and any optional components that are also mixed in at this time). Mechanical mixers and stirrers of various types may be used. Two preferred types of mixers are static mixers and impingement mixers.

A mixing and dispensing apparatus of particular interest is an impingement mixer. Mixers of this type are commonly used in so-called reaction injection molding processes to form polyurethane and polyurea moldings. The epoxy resin and hardener (and other components which are mixed in at this time) are pumped under pressure into a mixing head where they are rapidly mixed together. Operating pressures in high pressure machines may range from 1,000 to 2,000 psi or higher (6.9 to 13.8 MPa or higher), although some low pressure machines can operate at significantly lower pressures. The resulting mixture is then preferably passed through a static mixing device to provide further additional mixing, and then transferred into the mold cavity. The static mixing device may be designed into the mold. This has the advantage of allowing the static mixing device to be opened easily for cleaning. Using this impingement mixing method, the reaction mixture is usually transferred into the mold within 10 seconds or less after the epoxy resin and hardener are first brought into contact.

An especially preferred apparatus for conducting the process is a reaction injection molding machine, such as is commonly used to processes large polyurethane and polyurea moldings. Such machines are available commercially from Krauss Maffei Corporation and Cannon USA.

In other embodiments, the hot reaction mixture is mixed as before, and then sprayed into the mold. Temperatures are maintained in the spray zone such that the temperature of the hot reaction mixture is maintained as described before.

The mold is typically a metal mold, but it may be ceramic or a polymer composite, provided that the mold is capable of withstanding the pressure and temperature conditions of the molding process. The mold contains one or more inlets, in liquid communication with the mixer(s), through which the reaction mixture is introduced. The mold may contain vents to allow gases to escape as the reaction mixture is injected.

The mold is typically held in a press or other apparatus which allows it to be opened and closed, and which can apply pressure on the mold to keep it closed during the filling and curing operations. The mold or press is provided with means by which heat can be provided.

As mentioned before, the reinforcement can take any of several forms. In molding processes, a particularly suitable reinforcement is a fiber preform. Alternatively, various other types of fibrous reinforcements can be used, including those continuous fiber rovings, cut fibers or chopped fibers. Non-fibrous reinforcements can also be used, but they are generally less preferred, except in some instances in which it is desired to produce a class A automotive surface.

The reinforcing agent is thermally stable and has a high melting temperature, such that the reinforcing agent does not degrade or melt during the molding process. Suitable fiber materials include, for example, glass, quartz, polyamide resins, boron, carbon and gel-spun polyethylene fibers. Non-fibrous reinforcing agents include particulate materials which remain solid under the conditions of the polymerization. They include, for example, glass flakes, aramid particles, carbon black, carbon nanotubes, various clays such as montmorillonite, and other mineral fillers such as wollastonite, talc, mica, titanium dioxide, barium sulfate, calcium carbonate, calcium silicate, flint powder, carborundum, molybdenum silicate, sand, and the like. Wollastonite and mica are preferred reinforcing agents, either by themselves or in conjunction with a fiber reinforcing agent, when producing parts having a high distinctness of image (DOI), such as automotive body parts that require a class A automotive surface.

Some fillers are somewhat electroconductive, and their presence in the composite can increase the electroconductivity of the composite. In some applications, notably automotive applications, it is preferred that the composite is sufficiently electroconductive that coatings can be applied to the composite using so-called “e-coat” methods, in which an electrical charge is applied to the composite and the coating becomes electrostatically attracted to the composite. Conductive fillers of this type include metal particles (such as aluminum and copper) and fibers, carbon black, carbon nanotubes, carbon fibers, graphite and the like.

A preferred type of reinforcement is a fiber preform, i.e., a web or mat of fibers. The fiber preform can be made up of continuous filament mats, in which the continuous filaments are woven, entangled or adhered together to form a preform that approximates the size and shape of the finished composite article (or portion thereof that requires reinforcement). Alternatively, shorter fibers can be formed into a preform through entanglement or adhesive methods. Mats of continuous or shorter fibers can be stacked and pressed together, typically with the aid of a tackifier, to form preforms of various thicknesses, if required.

Suitable tackifiers for preparing performs (from either continuous or shorter fibers) include heat-softenable polymers such as described, for example, in U.S. Pat. Nos. 4,992,228, 5,080,851 and 5,698,318. The tackifier should be compatible with and/or react with the polymer phase of the composite, so that there is good adhesion between the polymer and reinforcing fibers. A heat-softenable epoxy resin or mixture thereof with a hardener, as described in U.S. Pat. No. 5,698,318, is especially suitable. The tackifier may contain other components, such as one or more catalysts, a thermoplastic polymer, a rubber, or other modifiers.

Fiber preforms are typically placed into the mold prior to introducing the hot reaction mixture. The hot reaction mixture can be introduced into a closed mold that contains the preform, by injecting the mixture into the mold, where the reaction mixture penetrates between the fibers in the preform and then cures to form a composite product. Reaction injection molding and/or resin transfer molding equipment is suitable in such cases. Alternatively, the preform can be deposited into an open mold, and the hot reaction mixture can be sprayed onto the preform and into the mold. After the mold is filled in this manner, the mold is closed and the reaction mixture cured. In either approach, the mold and the preform are preferably heated prior to contacting them with the reaction mixture, in order to maintain the temperature of the reaction mixture as described before.

Short fibers can be used instead or in addition to a fiber preform. Short fibers (up to about 6 inches in length, preferably up to 2 inches in length, more preferably up to about ½ inch in length) can be blended into the hot reaction mixture and injected into the mold with the hot reaction mixture. Such short fibers may be, for example, blended with the epoxy resin or hardener (or both), prior to heating and forming the reaction mixture. Alternatively, the short fibers may be added into the reaction mixture at the same time as the epoxy and hardener are mixed, or afterward but prior to introducing the hot reaction mixture into the mold. If the short fibers are added to the reaction mixture separately from the epoxy resin and hardener, they are preferably pre-heated to prevent them from cooling the reaction mixture below the temperatures described before.

Short fibers can be sprayed into a mold. In such cases, the hot reaction mixture can also be sprayed into the mold, at the same time or after the short fibers are sprayed in. When the fibers and reaction mixture are sprayed simultaneously, they can be mixed together prior to spraying. Alternatively, the fibers and reaction mixture can be sprayed into the mold separately but simultaneously. In a process of particular interest, long fibers are chopped into short lengths and the chopped fibers are sprayed into the mold, at the same time as or immediately before the hot reaction mixture is sprayed in.

Other particulate fillers can be incorporated into the reaction mixture in the same manner as described with respect to the short fibers.

Pultrusion processes use continuous fibers that are oriented parallel to each other, in the direction of extrusion. Pultrusion processes are operated in a manner analogous to molding processes, the main difference being that the hot reaction mixture is delivered into a resin bath rather than into a mold. The resin bath is a reservoir filled with the reaction mixture, through which the continuous fibers are pulled. The resin bath typically has some means, such as a series of pins, which separate the fibers slightly to permit them to be coated on all surfaces with the reaction mixture. Once the fibers are wetted with the hot reaction mixture, they are pulled through one or more dies, in which the fibers are consolidated and formed into the desired cross-sectional shape. The die(s) are heated, to temperatures as described before, to cause the reaction mixture to cure to form a polymer phase having a T_{g} of at least 150° C.

The epoxy resin and hardener are selected together such that they cure together to form a cured polymer having a T_{g} of at least 150° C. The epoxy resin preferably is a compound or mixture of compounds having an average functionality of greater than 2.0 epoxide groups per molecule. The epoxy resin or mixture thereof may have an average of up to 4.0 epoxide groups per molecule. It preferably has an average of from 2.0 to 3.0 epoxide groups per molecule.

The epoxy resin may have an epoxy equivalent weight of about 150 to about 1,000, preferably about 160 to about 300, more preferably from about 170 to about 250. If the epoxy resin is halogenated, the equivalent weight may be somewhat higher.

The epoxy resin may be solid or liquid at room temperature (˜22° C.), but should be liquid at 80° C.

Suitable epoxy resins include, for example, the diglycidyl ethers of polyhydric phenol compounds such as resorcinol, catechol, hydroquinone, bisphenol, bisphenol A, bisphenol AP (1,1-bis(4-hydroxylphenyl)-1-phenyl ethane), bisphenol F, bisphenol K, tetramethylbiphenol, diglycidyl ethers of aliphatic glycols and polyether glycols such as the diglycidyl ethers of C₂₋₂₄ alkylene glycols and poly(ethylene oxide) or poly(propylene oxide) glycols; polyglycidyl ethers of phenol-formaldehyde novolac resins, alkyl-substituted phenol-formaldehyde resins (epoxy novalac resins), phenol-hydroxybenzaldehyde resins, cresol-hydroxybenzaldehyde resins, dicyclopentadiene-phenol resins and dicyclopentadiene-substituted phenol resins, and any combination thereof.

Suitable diglycidyl ethers of polyhydric phenols include those represented by structure (I)

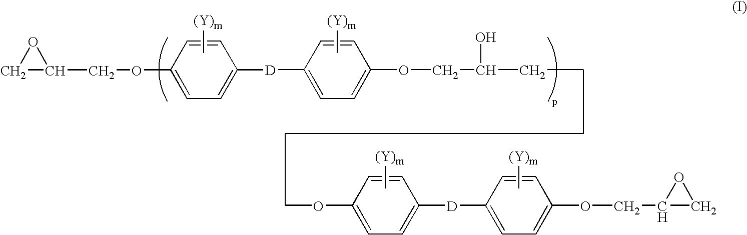

wherein each Y is independently a halogen atom, each D is a divalent hydrocarbon group suitably having from 1 to about 10, preferably from 1 to about 5, more preferably from 1 to about 3 carbon atoms, —S—, —S—S—, —SO—, —SO₂, —CO₃— —CO— or —O—, each m may be 0, 1, 2, 3 or 4 and p is a number from 0 to 5, especially from 0 to 2. Examples of suitable epoxy resins include diglycidyl ethers of dihydric phenols such as bisphenol A, bisphenol K, bisphenol F, bisphenol S and bisphenol AD, and mixtures thereof. Epoxy resins of this type are commercially available, including diglycidyl ethers of bisphenol A resins such as are sold by The Dow Chemical Company under the designations D.E.R™ 330, D.E.R™ 331, D.E.R.™ 332, D.E.R™ 383, D.E.R™ 661 and D.E.R.™ 662 resins.

Bromine-substituted epoxy resins of this type are commercially available from The Dow Chemical Company under the trade names D.E.R.™ 542 and D.E.R.™ 560. Other suitable halogenated epoxy resins are described in, for example, U.S. Pat. Nos. 4,251,594, 4,661,568, 4,710,429, 4,713,137, and 4,868,059, and The Handbook of Epoxy Resins by H. Lee and K. Neville, published in 1967 by McGraw-Hill, New York, all of which are incorporated herein by reference.

Commercially available diglycidyl ethers of polyglycols that are useful herein include those sold as D.E.R.™ 732 and D.E.R.™ 736 by The Dow Chemical Company.

Suitable epoxy novolac resins include cresol-formaldehyde novolac epoxy resins, phenol-formaldehyde novolac epoxy resins and bisphenol A novolac epoxy resins, including those available commercially as D.E.N.™ 354, D.E.N.™ 431, D.E.N.™ 438 and D.E.N.™ 439, all from The Dow Chemical Company.

Other suitable epoxy resins are cycloaliphatic epoxides. A cycloaliphatic epoxide includes a saturated carbon ring having an epoxy oxygen bonded to two vicinal atoms in the carbon ring, as illustrated by the following structure II:

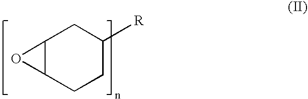

wherein R is an aliphatic, cycloaliphatic and/or aromatic group and n is a number from 1 to 10, preferably from 2 to 4. When n is 1, the cycloaliphatic epoxide is a monoepoxide. Di- or polyepoxides are formed when n is 2 or more. Mixtures of mono-, di- and/or polyepoxides can be used. Cycloaliphatic epoxy resins as described in U.S. Pat. No. 3,686,359, incorporated herein by reference, may be used in the present invention. Cycloaliphatic epoxy resins of particular interest are (3,4-epoxycyclohexyl-methyl)-3,4-epoxy-cyclohexane carboxylate, bis-(3,4-epoxycyclohexyl) adipate, vinylcyclohexene monoxide and mixtures thereof.

Other suitable epoxy resins include tris(glycidyloxyphenyl)methane, tetrakis(glycidyloxyphenyl)ethane, tetraglycidyl diaminodiphenylmethane and mixtures thereof.

Other suitable epoxy resins include oxazolidone-containing compounds as described in U.S. Pat. No. 5,112,932. In addition, an advanced epoxy-isocyanate copolymer such as those sold commercially as D.E.R.™ 592 and D.E.R.™ 6508 (The Dow Chemical Company) can be used.

The hardener is preferably a compound or mixture of compounds having an average of at least 2.0 epoxide-reactive groups per molecule. The hardener may have from 2.0 to 4.0 or more epoxide-reactive groups per molecule. The hardener preferably has an equivalent weight per epoxide-reactive group of from 30 to 1000, more preferably from 30 to 250 and especially from 30 to 150.

Epoxide-reactive groups are functional groups that will react with a vicinal epoxide to form a covalent bond. These groups include phenol, anhydride, isocyanate, carboxylic acid, amino or carbonate groups. Primary and secondary amino groups are preferred. Amino groups can be aliphatic or aromatic. Aromatic amines are especially preferred.

Suitable aromatic amine hardeners include dicyandiamide, phenylene diamine (particularly the meta-isomer), methylene dianiline, mixtures of methylene dianiline and polymethylene polyaniline compounds (sometimes referred to as PMDA, including commercially available products such as DL-50 from Air Products and Chemicals), diethyltoluenediisocyanate, and diaminodiphenylsulfone.

Suitable aliphatic amine hardeners include ethylene diamine, diethylene triamine, triethylenetetraamine, tetraethylenepentamine, aminoethylpiperazine and amine-epoxy resin adducts, such as are commercially available as D.E.H.™ 52 from The Dow Chemical Company.

Suitable phenolic hardeners include those represented by the structure (III)

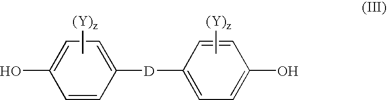

where each Y independently represents a halogen atom, each z is independently a number from 0 to 4 and D is a divalent hydrocarbon group as described with regard to structure I above. Examples of suitable phenolic hardeners include dihydric phenols such as bisphenol A, bisphenol K, bisphenol F, bisphenol S and bisphenol AD, and mixtures thereof, and their mono-, di-, tri- and tetra-brominated counterparts.

Phenolic hardeners having three or more phenolic groups, such as tetraphenol ethane, phenol novolacs or bisphenol A novolacs may also be used.

Another useful class of hardeners includes amino-functional polyamides. These are available commercially under as Versamide® 100, 115, 125 and 140, from Henkel, and Ancamide® 100, 220, 260A and 350A, from Air Products and Chemicals.

Suitable anhydride hardeners include, for example, styrene-maleic anhydride copolymers, nadic methyl anhydride, hexahydrophthalic anhydride, methylhexahydrophthalic anhydride, trimellitic anhydride, dodecyl succinic anhydride, phthalic anhydride, methyltetrahydrophthalic anhydride and tetrahydrophthalic anhydride.

Suitable isocyanate hardeners include toluene diisocyanate, methylene diphenyldiisocyanate, hydrogenated toluene diisocyanate, hydrogenated methylene diphenyldiisocyanate, polymethylene polyphenylene polyisocyanates (and mixtures thereof with methylene diphenyldiisocyanate, commonly known as “polymeric MDI”), isophorone diisocyanate, and the like.

Other curing agents useful in the present invention are described in U.S. Published Patent Application No. 2004/0101689, incorporated herein by reference.

Various optional components can be added into the reaction mixture, in addition to the epoxy resin and the hardener. These include, for example, one or more catalysts, solvents or diluents, mineral fillers, pigments, antioxidants, preservatives, impact modifiers, wetting agents and the like.

Suitable catalysts are described in, for example, U.S. Pat. Nos. 3,306,872, 3,341,580, 3,379,684, 3,477,990, 3,547,881, 3,637,590, 3,843,605, 3,948,855, 3,956,237, 4,048,141, 4,093,650, 4,131,633, 4,132,706, 4,171,420, 4,177,216, 4,302,574, 4,320,222, 4,358,578, 4,366,295, and 4,389,520, all incorporated herein by reference. Examples of suitable catalysts are imidazoles such as 2-methylimidazole; 2-ethyl-4-methylimidazole; 2-phenyl imidazole; tertiary amines such as triethylamine, tripropylamine and tributylamine; phosphonium salts such as ethyltriphenylphosphonium chloride, ethyltriphenylphosphonium bromide and ethyltriphenyl-phosphonium acetate; ammonium salts such as benzyltrimethylammonium chloride and benzyltrimethylammonium hydroxide; and mixtures thereof.

Although a catalyst may be used, one advantage of the invention is that fast curing times can often be achieved without using a catalyst, or by using only very small quantities of the catalyst, particularly when an amine hardener is used. Elimination or reduction of the amount of catalyst also provides the benefit of increasing the amount of time that the reaction mixture takes to become highly viscous or form gels. This provides greater processing latitude during the mixing and mold filling steps. Accordingly, in preferred embodiments, no catalyst is used. If a catalyst is used, the amount of the catalyst used generally ranges from about 0.001 to about 2 weight percent, but preferably is no greater than about 0.5 weight percent, based on the weight of the epoxy resin.

A solvent may also be used, but again it is preferred to omit this. The solvent is a material in which the epoxy resin, or hardener, or both, are soluble, at the temperature at which the epoxy resin and hardener are mixed. The solvent is not reactive with the epoxy resin(s) or the hardener under the conditions of the polymerization reaction. The solvent (or mixture of solvents, if a mixture is used) preferably has a boiling temperature that is at least equal to and preferably higher than the temperatures employed to conduct the polymerization. Suitable solvents include, for example, glycol ethers such as ethylene glycol methyl ether and propylene glycol monomethyl ether; glycol ether esters such as ethylene glycol monomethyl ether acetate and propylene glycol monomethyl ether acetate; poly(ethylene oxide) ethers and poly(propylene oxide) ethers; polyethylene oxide ether esters and polypropylene oxide ether esters; amides such as N,N-dimethylformamide; aromatic hydrocarbons toluene and xylene; aliphatic hydrocarbons; cyclic ethers; halogenated hydrocarbons; and mixtures thereof. If used, the solvent may constitute up to 75% of the weight of the reaction mixture, more preferably up to 30% of the weight of the mixture. Even more preferably the reaction mixture contains no more than 5% by weight of a solvent and most preferably contains less than 1% by weight of a solvent.

Suitable impact modifiers include natural or synthetic polymers having a T_{g} of lower than −40° C. These include natural rubber, styrene-butadiene rubbers, polybutadiene rubbers, isoprene rubbers, core-shell rubbers, and the like. The rubbers are preferably present in the form of small particles that become dispersed in the polymer phase of the composite. The rubber particles can be dispersed within the epoxy resin or hardener and preheated together with the epoxy resin or hardener prior to forming the hot reaction mixture.

The process of the invention is useful to make a wide variety of composite products, including various types of automotive parts. Examples of these automotive parts include vertical and horizontal body panels, automobile and truck chassis components, and so-called “body-in-white” structural components.

Body panel applications include fenders, door skins, hoods, roof skins, decklids, tailgates and the like. Body panels often require a so-called “class A” automotive surface which has a high distinctness of image (DOI). For this reason, the filler in many body panel applications will include a material such as mica or wollastonite. In addition, these parts are often coated in the so-called “e-coat” process, and for that reason must be somewhat electroconductive. Accordingly, an electroconductive filler as described before may be used in body panel applications to increase the electrical conductivity of the part. An impact modifier as described before is often desired in body panel applications to toughen the parts. Short cycle times are usually of high importance to the economics of body panel manufacture. For this reason, more highly reactive epoxy resins and hardeners are favored in these applications, and the preheating temperature may be somewhat higher than 80° C. Body panel cycle times are preferably no more than 3 minutes, more preferably no more than 2 minutes and even more preferably no more than 1 minute.

Automotive and truck chassis components made in accordance with the invention offer significant weight reductions compared to steel. This advantage is of most significance in large truck applications, in which the weight savings translate into larger vehicle payload. Automotive chassis components provide not only structural strength, but in many cases (such as floor modules) provide vibration and sound abatement. It is common to apply a layer of a dampening material to steel floor modules and other chassis parts to reduce sound and vibration transmission through the part. Such dampening materials can be applied in similar manner to a composite floor module made in accordance with this invention.

The following examples are provided to illustrate the invention, but not limit the scope thereof. All parts and percentages are by weight unless otherwise indicated.

### EXAMPLE 1

### Preparation of Composite Laminate

A 7″×8″ (18×18 cm) mold of the plunger and cavity type is sprayed with a mold release agent. A layer of a plane weave E-glass fabric (18 g) is loaded into the mold, and the mold and glass fabric are heated to 180° C.

An epoxy resin having an epoxide equivalent weight of about 180 (DER™ 383, from The Dow Chemical Company) is pre-heated to 80° C. in a holding tank. In a separate holding tank, a mixture of methylene dianiline and polymethylene polyanilines (ANCAMINE® DL50, from Air Products and Chemicals) is also pre-heated to 80° C. Both material streams are then separately transferred using a pump heated at 125° C. to a static mixer where they are rapidly mixed at a weight ratio of 27.4 parts by weight hardener and 72.6 parts by weight epoxy resin. The resulting hot (125° C.) mixture is then immediately transferred into the preheated mold. The mold is rapidly shut, and maintained at 180° C. for 5 minutes. The mold is then cooled and opened, and the resulting composite is removed. The resulting composite is roughly 0.13 inches thick.

˜2.5 g pieces of the laminate are weighed, placed in a crucible and heated in an oven under air at 600° C. until the organic phase is burned out. The samples are then cooled down and re-weighed. Fiber weight fraction is calculated by dividing the fiber weight obtained after burn-out by the original weight of the sample.

T_{g} of the polymer phase is measured by differential scanning calorimetry (DSC). T_{g} testing is also evaluated by Dynamic Mechanical Thermal Analysis (DMTA), on rectangular samples roughly 12 mm wide and 25 mm long. The DMTA analysis is conducted on a Rheometrics ARES rheometer using a solid-state rectangular sample fixture. Fixed frequency (1 Hz) torsional-mode experiments are run starting at 30° C. and then applying a steady temperature ramp of 3° C./min to a temperature of 250° C.

Room temperature flexure testing is performed in accordance with ASTM D790 testing. Specimens 0.5 inches wide and 3.5 inches long are cut from the laminate using a water-cooled circular tile saw, polished on the edges using 600 grit sand paper and left to condition in accordance with the standard. The specimens are then loaded on a 3-point bending fixture with a support span of 2 inches (˜5.1 cm) and a loading rate of 0.054 inches/minute (˜0.023 mm/s).

Room temperature tensile testing is conducted on straight edge specimens 1 inch (2.5 cm) wide and 6 inches (15 cm) long. Testing is conducted using an Instron 4505 test frame fitted with a ten thousand pound (44480 N) load cell. The specimen is gripped using self tightening grips and a grip length of 1.5 inches (3.8 cm) on either side. The loading rate is 0.2 inches (0.5 cm) per second. An extensiometer with a 2 inch (5.1 cm) gauge length is used to monitor strain during the test.

Results from the foregoing testing are as reported in Table 1.

TABLE 1

| Property | Value |
|---|---|
| Cure Time, minutes | 5 |
| Fiber Content, % by weight | 47 |
| Fiber Content, % by volume | 29 |
| T_{g}(DMTA method), ° C. | 183 |
| Tensile Modulus, Mpsi (GPa) | 2.3 (16) |
| Tensile Strength, kpsi (MPa) | 32 (221) |
| Flexural Modulus, Mpsi (GPa) | 1.6 (11) |
| Flexural Strength, kpsi (MPa) | 48 (330) |
| Elongation at break, % | 3.6 |

The particular epoxy resin used in this example is formulated by its manufacturer to provide a slow cure. Nonetheless, the polymer phase cures to a T_{g} in excess of 150° C. in less than 5 minutes. A more reactive epoxy resin would be expected to provide an even shorter cure time.

What is claimed is:

1. A process for forming a composite, comprising;
a) pre-heating an epoxy resin and a hardener while keeping them separated;
b) mixing the pre-heated epoxy resin and pre-heated hardener to form a hot reaction mixture;
c) curing the hot reaction mixture in the presence of at least reinforcement to form a composite having a polymer phase, until the polymer phase attains a glass transition temperature of at least 150° C.,
wherein steps b) and c) are conducted such that the hot reaction mixture is maintained at all times above the instantaneous T_{g} of the polymer phase.

2. The process of claim 1, wherein in step b), the hot reaction mixture has a temperature of at least 80° C. when first formed.

3. The process of claim 2, wherein step c) is conducted by introducing the hot reaction mixture into a closed mold, and curing the hot reaction mixture in the closed mold.

4. The process of claim 3, wherein the mold is heated to at least 130° C. before introducing the hot reaction mixture into the mold.

5. The process of claim 4, wherein the mold is heated to at least 160° C. while the hot reaction mixture is curing in the mold.

6. The process of claim 3 wherein the reinforcement is a fiber preform.

7. The process of claim 6 wherein the preform is in the mold before introducing the hot reaction mixture, and the preform and the mold are each heated to at least 150° C. before introducing the hot reaction mixture into the mold.

8. The process of claim 7 wherein the mold is heated to at least 160° C. while the reaction mixture is curing in the mold.

9. The process of claim 8 wherein the hot reaction mixture contains no more than 0.5 weight percent of a catalyst, based on the weight of the epoxy resin.

10. The process of claim 9, wherein the hot reaction mixture contains no more than 1 percent by weight of a solvent.

11. The process of claim 3, wherein the reinforcement includes short fibers.

12. The process of claim 11, wherein the short fibers are introduced into the hot reaction mixture prior to introducing the hot reaction mixture into the mold.

13. The process of claim 12 wherein the hot reaction mixture contains no more than 0.5 weight percent of a catalyst, based on the weight of the epoxy resin.

14. The process of claim 13, wherein the hot reaction mixture contains no more than 1 percent by weight of a solvent.

15. The process of claim 1, wherein the epoxy resin has an average functionality of from 2.0 to 3.0 epoxide groups per molecule and an epoxide equivalent weight of from 170 to 250.

16. The process of claim 15, wherein the epoxy resin in a diglycidyl ether of a polyhydric phenol compound.

17. The process of claim 16, wherein the hardener has from 2.0 to 4.0 epoxide reactive groups per molecule and an equivalent weight per epoxide-reactive group of from 30 to 250.

18. The process of claim 17, wherein the hardener is an aromatic amine hardener.

19. A process for forming a composite, which comprises
a) pre-heating an epoxy resin and a hardener while keeping them separated;
b) mixing the pre-heated epoxy resin and pre-heated hardener to form a hot reaction mixture;
c) introducing the hot reaction mixture into a closed mold containing at least one fiber perform, and
d) curing the hot reaction mixture in the presence of at least reinforcement mold to form a composite having a polymer phase, until the polymer phase attains a glass transition temperature of at least 150° C.,
wherein steps b), c and d) are conducted such that the hot reaction mixture is maintained at all times above the instantaneous T_{g} of the polymer phase.

20. A resin transfer molding process, comprising;
a) preheating an epoxy resin and a hardener while keeping them separated;
b) mixing the heated epoxy resin and heated hardener to form a hot reaction mixture having a temperature of at least 80° C.;
c) introducing the hot reaction mixture into a closed mold containing at least one fiber preform, wherein said mold and fiber perform are at a temperature of at least 160° C. when the mixture is introduced into the mold; and
d) curing the mixture in the mold at a temperature of at least 160° C. until the mixture cures to form a composite having a polymer phase with a glass transition temperature of at least 150° C.
